(19) United States
(12) Patent Application Publication
(10) Pub. No.: US 2010/0251899 A1
(43) Pub. Date: Oct. 7, 2010

(54) BREWING DEVICE OF COFFEMAKER

(76) Inventor: Yu-Yuan Lin, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/416,191

(22) Filed: Apr. 1, 2009

(51) Int. Cl. A47J 31/44; A47J 31/10

(52) U.S. Cl. 99/284; 99/306

(57) ABSTRACT

A brewing device of a coffeemaker includes a base to which a filter cup loaded with ground coffee is assembled from below. Hot water in a heating tank of a delivery system is guided into a guide tube of the brewing device, flows through a sliding element and a downward pressing element, and finally drips onto and thus infuses the ground coffee in the filter cup, thereby making caffè espresso. When the delivery system switches to a different waterway and guides the hot water through a lower water inlet opening at the filter cup, caffè Americano, i.e., a diluted caffè espresso, is made instead. Thus, the coffeemaker is capable of making both caffè espresso and caffè Americano. Besides, the hot water guided through the lower water inlet opening at the filter cup also purges a bottom space in the filter cup of coffee ground.

### BACKGROUND OF THE INVENTION

1. Technical Field

The present invention relates to a brewing device of a coffeemaker, wherein the brewing device is configured with an upper waterway and a lower waterway so as to dilute coffee as needed.

2. Description of Related Art

Coffeemakers are well known in the art. Conventionally, ground coffee, which is prepared by grinding coffee beans into granules, is filled into a filter cup to be coupled with a coffeemaker, and is then compressed and flattened with a tamper to reduce the voids and air between the coffee granules. Following that, the coffeemaker is turned on, allowing hot water to drip onto and thereby infuse the ground coffee in the filter cup so that coffee is extracted. However, the process mentioned above for making coffee by dripping hot water onto a fixed amount of ground coffee only produces coffee of the same strength. When weaker coffee is desired, the coffee extracted by the aforesaid process must be poured into a container such as a coffeepot, added with hot water, and stirred well so as to make dilute coffee. Since hot water is not always available, the addition of hot water may be a problem. Also, coffee ground residue tends to remain in a bottom space in the filter cup so as to compromise the quality of coffee prepared with the same filter cup in the next shot.

### BRIEF SUMMARY OF THE INVENTION

In view of the above and realizing that the conventional way of drip brewing with a singular upper waterway causes much inconvenience in use, the inventor of the present invention exercised his professional knowledge accumulated through years of experience in design and manufacture and finally succeeded, through repeated trials with ingenious ideas, in developing a brewing method using an upper waterway and a lower waterway, which are easily switched to make a coffeemaker capable of making both strong and weak coffee.

The primary objective of the present invention is to provide a brewing device of a coffeemaker, wherein a filter cup loaded with ground coffee is assembled to a base of the brewing device from below, and hot water in a heating tank of a delivery system is guided into a guide tube of the brewing device, flows through a sliding element and a downward pressing element, and finally drips onto and thereby infuses the ground coffee in the filter cup, thereby making caffè espresso. When the delivery system switches to a different waterway, the hot water is guided through a lower water inlet opening at the filter cup so as to make caffè americano as a result of dilution. Thus, the coffeemaker is capable of making both strong and weak coffee.

The secondary objective of the present invention is to provide the foregoing brewing device, wherein the hot water guided through the lower water inlet opening at the filter cup also purges a bottom space in the filter cup of coffee ground.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is an exploded perspective view of a brewing device according to the present invention;

FIG. 2 is an assembled perspective view of the brewing device according to the present invention;

FIG. 3 is an assembled top view of the brewing device according to the present invention;

FIG. 4 is a detailed sectional view taken along line 40-40 in FIG. 3;

FIG. 5 is a schematic drawing showing hot water being delivered through an upper waterway by a delivery system according to the present invention;

FIG. 6 illustrates how strong coffee is made by the brewing device according to the present invention;

FIG. 7 is a schematic drawing showing hot water being delivered through a lower waterway by the delivery system according to the present invention; and

FIG. 8 illustrates how weak coffee is made by the brewing device according to the present invention.

### DETAILED DESCRIPTION OF THE INVENTION

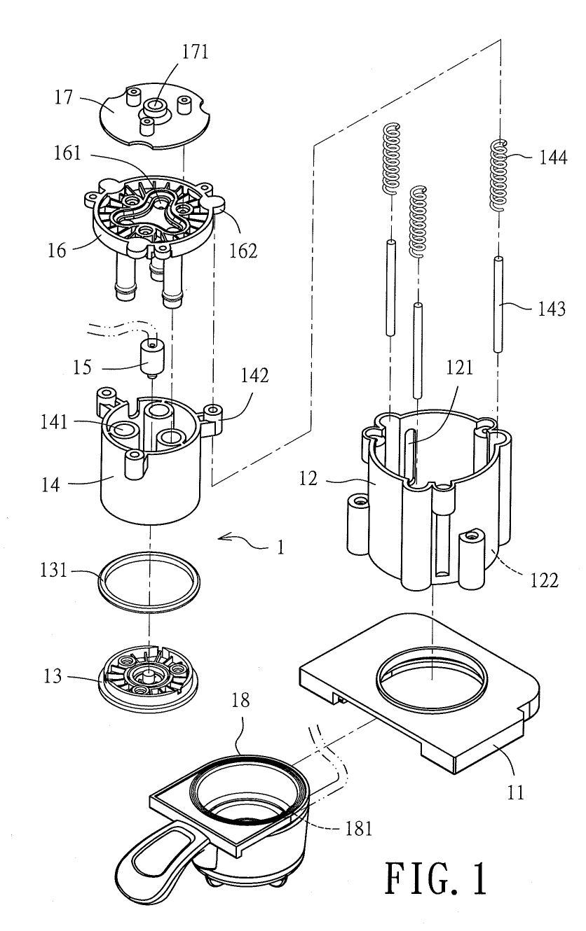

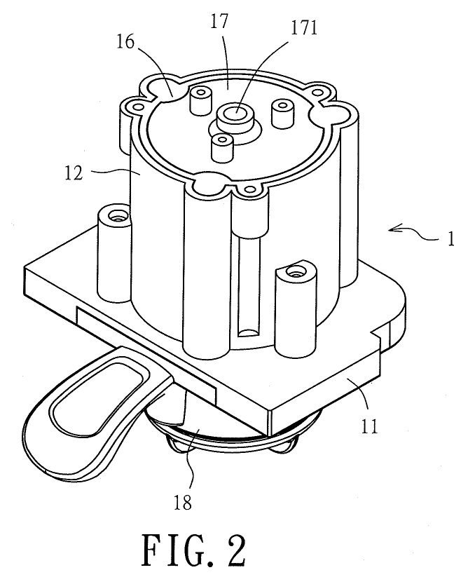

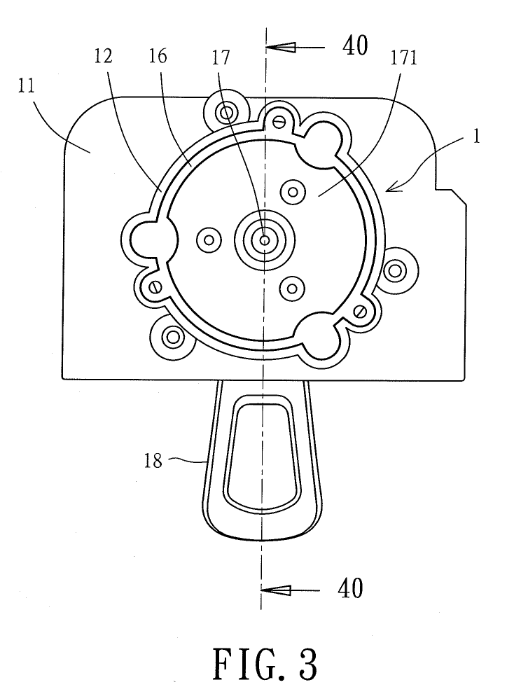

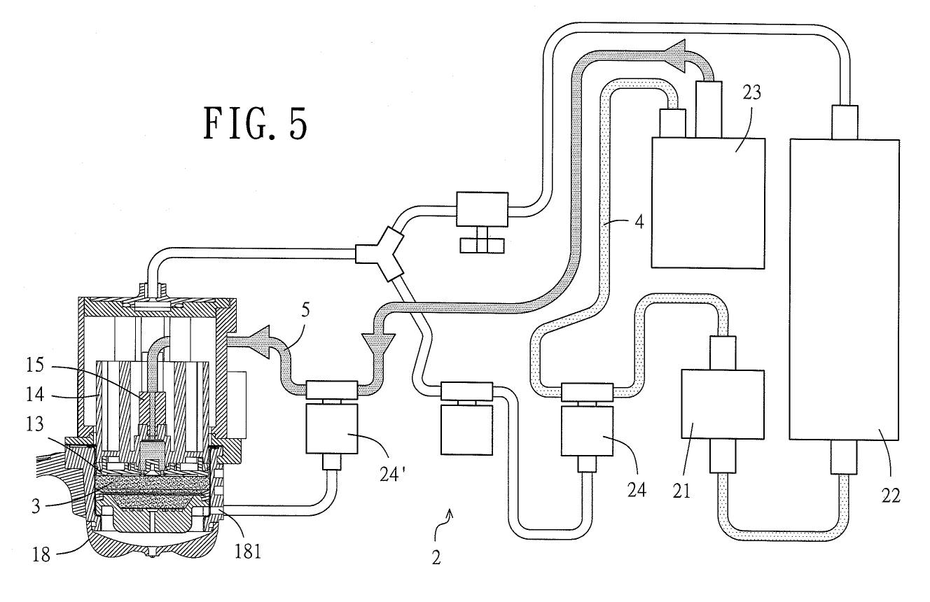

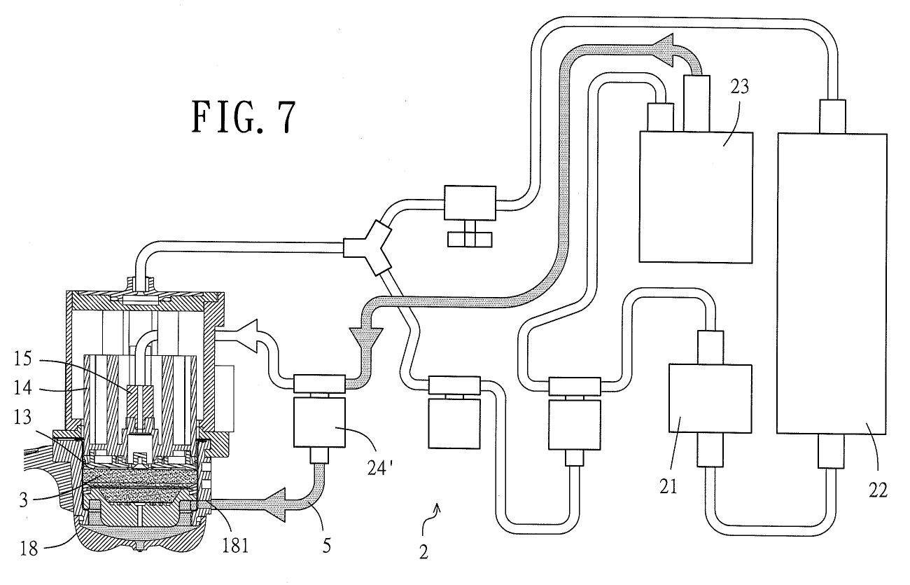

Referring to FIGS. 1 through 4, a brewing device 1 of a coffeemaker according to the present invention is coupled with a delivery system 2 (see FIGS. 5 and 7) and configured as follows.

The brewing device 1 includes a base 11 with which an outer annular body 12 having a slot 121 is coupled from above. The outer annular body 12 is installed therein sequentially with a downward pressing element 13 provided with an O-ring 131, a sliding element 14 provided with a guide tube 15, and an upper cover 16 provided with a lid 17. The sliding element 14 is formed with a plurality of water receiving sections 141 and peripherally extended with a plurality of retaining portions 142. The upper cover 16 is formed with a plurality of water inlet sections 161 and a plurality of engaging portions 162 corresponding in position to the water receiving sections 141 and the retaining portions 142 of the sliding element 14, respectively. In addition, a plurality of shafts 143 are engaged with and between engaging portions 122 of the outer annular body 12 and the engaging portions 162 of the upper cover 16, respectively. The shafts 143 also pass through the retaining portions 142 of the sliding element 14, respectively, while a spring 144 is mounted around each shaft 143. Besides, the delivery system 2 is coupled to one side of the brewing device 1.

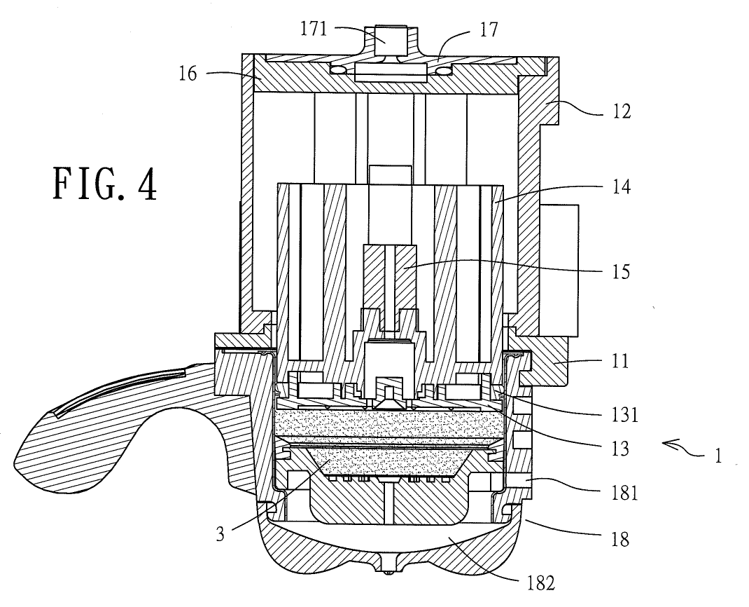

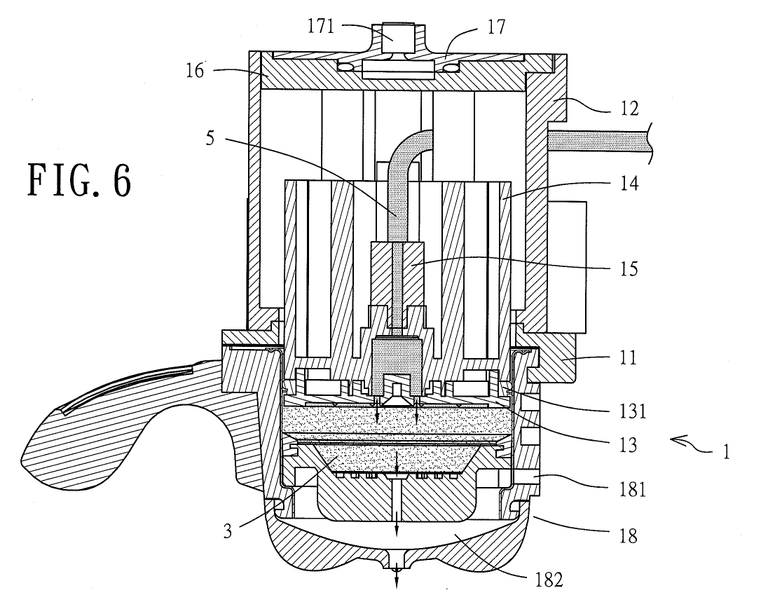

The brewing device 1 operates in the following manner. To begin with, a fixed amount of ground coffee 3 is loaded into a filter cup 18, as shown in FIG. 4. Then, a pump 21 in the delivery system 2 draws cool water 4 from a cool water tank 22. The cool water 4 flows through a three-way solenoid valve 24 and enters a heating tank 23 so as to be heated for later use. Next, the downward pressing element 13 is driven to compact the loose ground coffee 3 in the filter cup 18. (The compacting of the ground coffee 3 is not a major feature of the present invention and therefore is not described in detail herein.) Subsequently, hot water 5 in the heating tank 23 of the delivery system 2 is guided into the guide tube 15 of the brewing device 1, as shown in FIG. 5. After flowing through the sliding element 14 and the downward pressing element 13, the hot water 5 drips onto and thus infuses the ground coffee 3 in the filter cup 18 so that caffè espresso is made, as shown in FIG. 6.

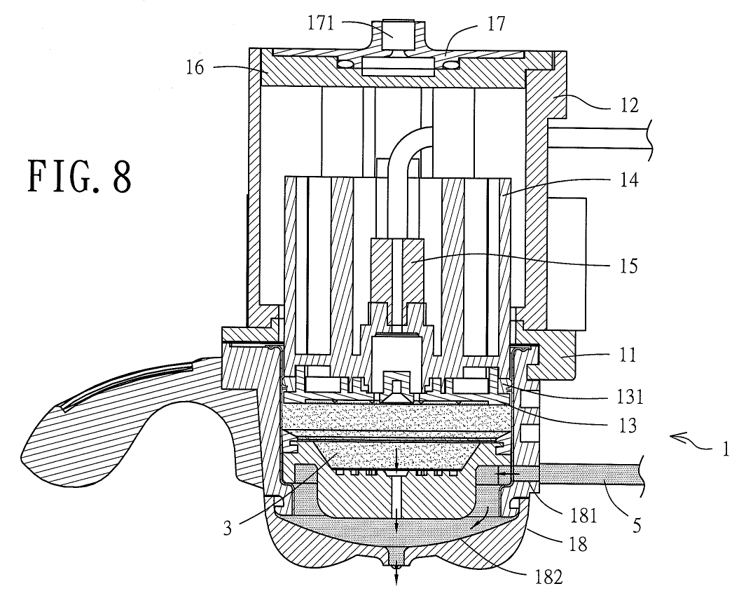

When it is desired to make caffè americano, the delivery system 2 switches to a different waterway by means of a three-way solenoid valve 24′ after the hot water 5 has flown through the guide tube 15 for a while. Thus, the hot water 5 is diverted into a lower water inlet opening 181 at the filter cup 18, as shown in FIG. 7, thereby diluting the coffee extracted with the hot water 5 coming through the guide tube 15, as shown in FIG. 8. Meanwhile, the hot water 5 entering through the lower water inlet opening 181 also purges a bottom space 182 in the filter cup 18 of coffee ground in a rapid and convenient fashion.

In addition, the O-ring 131 is provided peripherally on the downward pressing element 13 so as to seal a gap between the downward pressing element 13 and the filter cup 18, thereby preventing the hot water 5 used for brewing from leaking through the gap.

1. A brewing device of a coffeemaker, the brewing device comprising a base to which a filter cup loaded with ground coffee is assembled from below, wherein hot water in a heating tank of a delivery system is guided into a guide tube of the brewing device so as to flow through a sliding element and a downward pressing element and drip onto and thus infuse the ground coffee in the filter cup, thereby making strong coffee, and when the delivery system switches to a different waterway and guides the hot water through a lower water inlet opening at the filter cup, weak coffee is made as a result of dilution, thus enabling the coffeemaker to make both the strong coffee and the weak coffee.

2. The brewing device of claim 1, wherein the hot water guided through the lower water inlet opening at the filter cup purges a bottom space in the filter cup of coffee ground.

3. The brewing device of claim 1, wherein the downward pressing element is provided peripherally with an O-ring for sealing a gap between the downward pressing element and the filter cup, thereby preventing the hot water used for brewing from leaking through the gap.

4. The brewing device of claim 1, wherein the delivery system switches to the different waterway by means of a three-way solenoid valve.
